(19) United States
(12) Patent Application Publication
(10) Pub. No.: US 2025/0013276 A1
(43) Pub. Date: Jan. 9, 2025

(54) FAN EXHAUST RECIRCULATION PREVENTION IN ELECTRONIC DEVICES

(71) Applicants: Shantanu Kulkarni, Hillsboro, OR (US); Shawn Mceuen, Portland, OR (US); James Raupp, Hillsboro, OR (US)

(72) Inventors: Shantanu Kulkarni, Hillsboro, OR (US); Shawn Mceuen, Portland, OR (US); James Raupp, Hillsboro, OR (US)

(21) Appl. No.: 18/891,259

(22) Filed: Sep. 20, 2024

(51) Int. Cl. G06F 1/20; G06F 1/16

(52) U.S. Cl. CPC G06F 1/203; G06F 1/1675

(57) ABSTRACT

Systems, apparatus, articles of manufacture, and methods are disclosed to reduce or prevent fan exhaust recirculation in electronic devices. An example electronic device includes a first panel; a second panel; a hinge coupling the first panel and the second panel; and a gating plate movable with the first panel to reduce recirculation of airflow in the second panel.

### BACKGROUND

Laptops include a base and a display. The display is connected to the base via a hinge. The base includes heat generating components such as a central processing unit, memory, and power supply components.

### BRIEF DESCRIPTION OF THE DRAWINGS

FIG. 1 shows a prior art electronic device.

FIG. 2 is a schematic illustration of a portion of an example electronic device with an example gating plate in accordance with teachings of this disclosure.

FIG. 3A and FIG. 3B are schematic side-view illustrations of a portion of the example electronic device of FIG. 2 with a first panel of the electronic device in a first position and the gating plate is in a first position.

FIG. 4 is a schematic illustration of the portion of electronic device FIG. 2 with the first panel in a second position and the gating plate in the first position.

FIG. 5A and FIG. 5B are schematic illustrations of the portion of the example electronic device of FIG. 2 with the first panel in a third position and the gating plate in the first position.

FIG. 6A and FIG. 6B are schematic illustrations of the portion of the example electronic device of FIG. 2 with the first panel in a fourth position and the gating plate in a second position.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Electronic devices such as laptop computers include fans that dissipate heat from the interior of the electronic device as part of the thermal solutions. The fans intake fresh or ambient air via one or more intake vents. In the interior of the electronic device, the air absorbs heat generated by one or more electronic components within the base. The heated air or fan exhaust exits the electronic device via an exhaust vent.

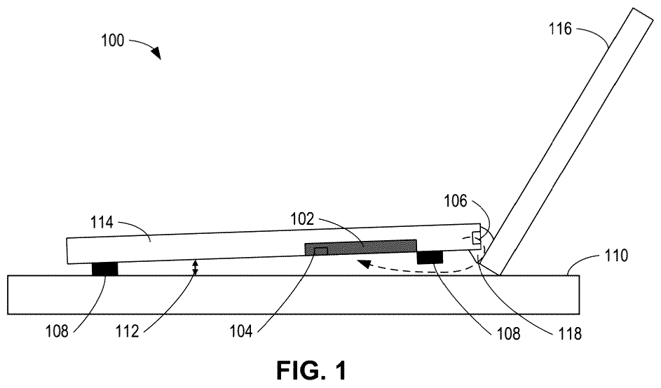

FIG. 1 shows a known electronic device 100 that includes a fan 102 to dissipate heat from the interior of the electronic device 100. The electronic device includes intake vents 104 on the bottom of the electronic device 100 and exhaust vents 106 on the rear of the electronic device 100. The electronic device 100 includes feet 108 that support the electronic device on a surface 110 such as a desk or table. The feet 108 create a gap 112 between a bottom panel 114 of the electronic device 100 and the surface 110. The size of the gap 112 correlates to the amount of impedance to airflow through the intake vents 104. Inlet impedance for the flow generally amounts to 40%-50% of total system impedance. Inlet flow impedance is determined by venting (area, open ratio) and feet height. The smaller the gap 112, the greater the inlet impedance. Likewise, the larger the gap 112, the lower the inlet impedance. Electronic devices with smaller z-height, may have thinner feet (i.e., shorter feet) height, which can increase inlet impedance.

A top or display panel 116 is coupled to the bottom panel 114 via a hinge 118. As the display panel 116 opens, a lower portion of the display panel 116 and/or the hinge 118 approaches and, in some instances, engages the surface 110. Engagement with the surface 110 lifts a portion of the bottom panel 114 near the hinge 118 from the surface 110. Lifting the portion of the bottom panel 114 near the hinge 118 from the surface 110 increases the size of the gap 112 to lower inlet impedance and increase air flow into the electronic device 100. Regardless of whether the display panel 116 lifts the bottom panel 114, the fan exhaust from the exhaust vents 106 hits the display panel 116 and flows down around the hinge 118 and into the gap 112, which is the intake area for air into the intake vents 104. Thus, warm fan exhaust is recirculated back into the electronic device 100. Warmer air is less effective for cooling the electronic device 100. The warmer air reduces the benefit of the increased air flow and lowered inlet impedance, which may be present in laptops where the display panel lifts the bottom panel.

Examples disclosed herein reduce (e.g., prevent) the recirculation air flow path noted above while enabling the decrease of inlet impedance. Examples disclosed herein include an example gating plate that is connected to an example hinge barrel of an electronic device. The gating plate is movable between a stowed position and a deployed position. When a lid or display panel of the electronic device is in an opened position (e.g., at a certain angle with respect to the bottom panel of the electronic device), the grating plate is deployed and blocks fan exhaust from rear vents of the electronic device from being directed down and under the electronic device. Thus, the air flow into intake vents on the bottom of the electronic device is not mixed with warm fan exhaust.

In some examples, a lower portion of the display panel and/or the hinge engages a surface that supports the electronic device. When portion of the display panel and/or the hinge engages the surface, a portion of the bottom panel near the hinge is lifted from the surface, which lowers inlet impedance at the intake vents on the bottom of the electronic device. In addition, when the display panel is in this position, the grating plate is deployed as disclosed above. In such examples, inlet impedance to the intake vents is reduced and warm air from the exhaust vents is prevented from recirculation into the intake vents.

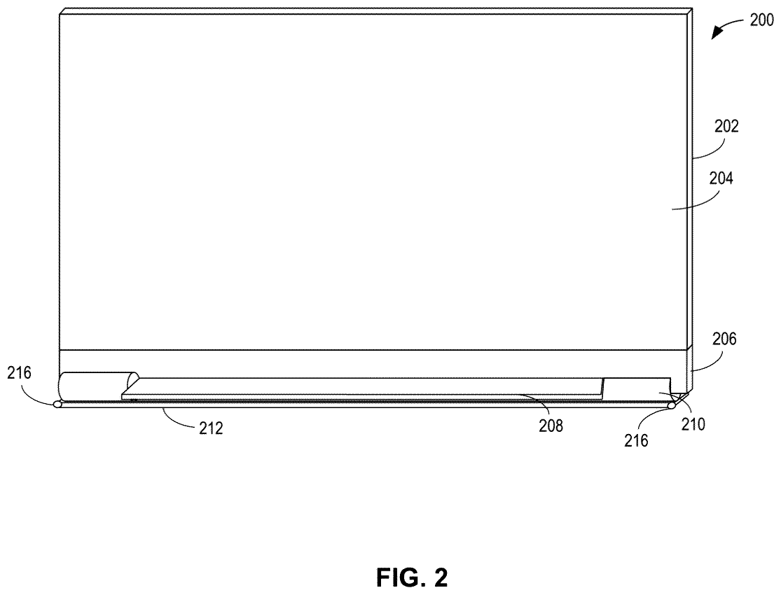

FIG. 2 is a schematic illustration of a portion of an example electronic device 200 that includes an example first panel or display panel 202. The display panel 202 supports or houses an example display 204. The electronic device 200 also includes an example hinge 206. The hinge 206 includes an example hinge barrel 208 and example hinge cover 210. The electronic device 200 also includes an example gating plate 212. In this example, the gating plate 212 extends the length of the hinge 206. In some examples, the gating plate 212 extends the width of the bottom or base panel of the electronic device 200. The gating plate 212 includes an example engagement surface 216 at both right and left ends of the gating plate 212. In some examples, the engagement surface 216 is a pin. In some examples, the engagement surface 216 is a fixed pin. In some examples, the engagement surface 216 is a rolling pin.

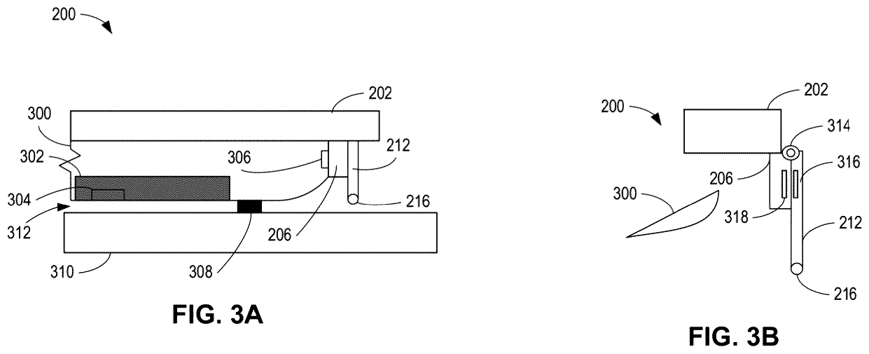

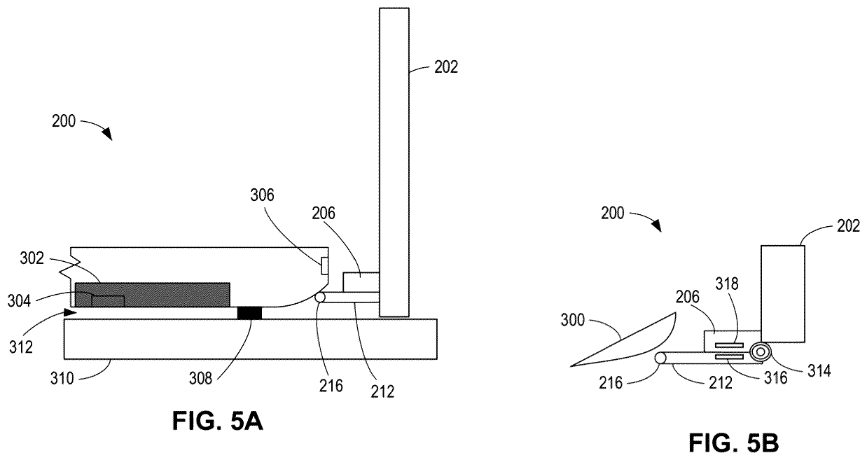

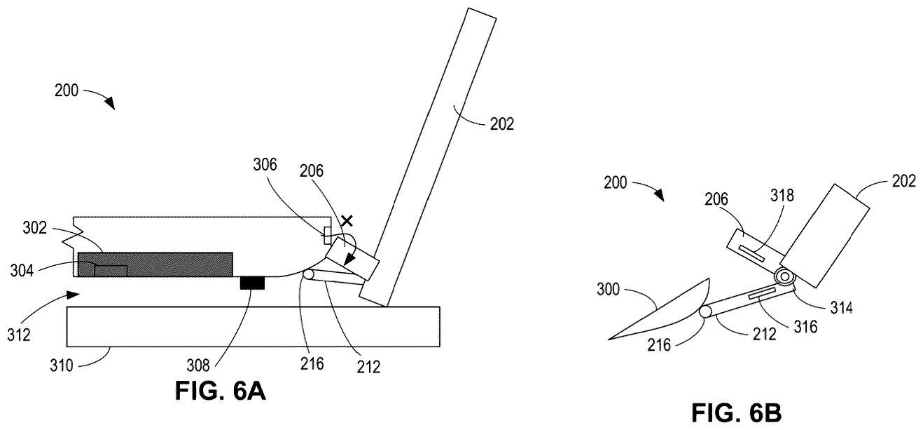

FIG. 3A and FIG. 3B are schematic side-view illustrations of a portion of the electronic device 200. The first panel or display panel 202 is coupled to an example second panel or base panel 300. The display panel 202 is coupled to the base panel 300 via the hinge 206. The display panel 202 is moveable between a first position or closed position, as shown in FIG. 3A, to a second position or open position as shown in FIG. 5A and/or FIG. 6A. As the display panel 202 moves from the closed position to the opened position, the angle between the display panel 202 and the base panel 300 increases. In the closed position of FIG. 3A, the angle between the display panel 202 and the base panel 300 is approximately zero degrees.

The base panel 300 includes an example fan 302. Rotation of the fan 302 draws fresh or ambient air into the base panel 300 via one or more example intake vents 304. In the illustrated example, the intake vents 304 are on a bottom side of the base panel 300. In the interior of the electronic device 200, the air brought in by the fan 302 absorbs heat from heat generating components such as, for example, a central processing unit, a graphic processing unit, a power supply, etc. The heated air or fan exhaust exits the electronic device 200 via an example exhaust vent 306. In the illustrated example, the exhaust vent 306 is at a rear side of the base panel 300 near the hinge 206.

The electronic device 200 also includes one or more example feet 308 to support the electronic device 200 on a support surface 310 such as a desk, table, etc. One foot 308 is shown in FIG. 3A, but the electronic device 200 may include a plurality of feet (e.g., four). The foot 308 shown in FIG. 3A is coupled to the bottom of the base panel 300. The foot 308 creates a gap 312 between the base panel 300 and the support surface 310. Fresh or ambient air flow in the gap 312 to the intake vent 304.

The gating plate 212 is in a first, stowed, or undeployed position in FIGS. 3A and 3B. The electronic device 200 includes an example biasing element 314. The biasing element 314 biases or urges the gating plate 212 to the stowed position. The gating plate 212 is coupled to the hinge 206. In some examples, the biasing element 314 is a torsion spring.

The gating plate 212 includes a first magnet 316, and the hinge 206 include second magnet 318. The first magnet 316 and the second magnet 318 are attracted to each other to urge or pull the gating plate 212 to and/or releasably hold the gating plate 212 in the stowed position. In some examples, one of the hinge 206 or the gating plate 121 includes a magnet (e.g., the first magnet 316 and/or the second magnet 318) and the other of the hinge 206 or the gating plate 212 includes a ferromagnetic element such as, for example, a metallic surface. The magnet and the magnetizable element are attracted to each other to urge or pull the gating plate 212 to and/or releasably hold the gating plate 212 in the stowed position. In examples disclosed herein, the biasing element 314 aids movement of the gating plate 212 under the attractive forces of the first magnet 316 and/or the second magnet 318 and vice versa.

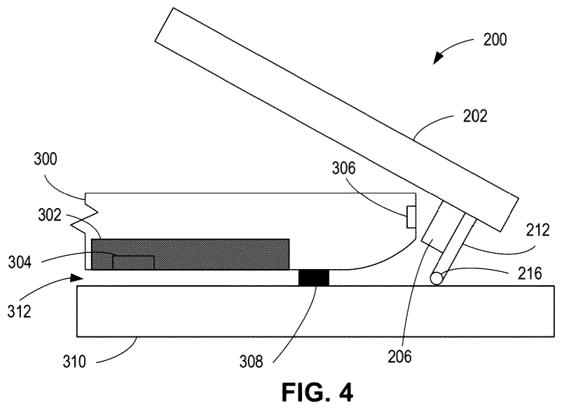

FIG. 4 shows the portion of electronic device 200 with the display panel 202 in a partially opened position in which the display panel 202 is separated from the base panel 300 by an angle. In this example, the angle is less than 90 degrees. In this position, the gating plate 212 is in the first, stowed, or undeployed position. In the position shown in FIG. 4, the engagement surface 216 is not in contact with the base panel 300.

FIG. 5A and FIG. 5B show the portion of the electronic device 200 with the display panel 202 in an opened position. In this example, the angle between the display panel 202 and the base panel 300 is approximately 90 degrees. In this position, the gating plate 212 is in the first, stowed, or undeployed position. In the position shown in FIG. 5A and FIG. 5B, the engagement surface 216 is in contact with the base panel 300. In examples disclosed herein, the engagement surface 216 of the gating plate 212 contacts the base panel 300 based on an angle of the display panel 202 relative to the base panel 300. In some examples, the engagement surface 216 contacts the base panel 300 when display panel 202 and the base panel 300 are separated by a threshold angle. In the example of FIG. 5A and FIG. 5B, the threshold angle is approximately 90 degrees or greater.

FIG. 6A and FIG. 6B show the portion of the electronic device 200 with the display panel 202 in another opened position and the gating plate 212 in a deployed position. In the example of FIG. 6A and FIG. 6B, the display panel 202 contacts the support surface 310 and lifts the foot 308 from the support surface to increase the size of the gap 312. When the size of the gap 312 is increased, there is less flow impedance into the intake vent 304 of the fan 302. In other examples, there is no lift of the base panel 300 due to the opening of the display panel 202.

When the display panel 202 is opened past approximately 90 degrees relative to the base panel 300, the force to open the display panel 202 overcomes the attractive force between the first magnet 316 and the second magnet 318 and the first magnet 316 and the second magnet 318 separate. In addition, the force to open the display panel 202 overcomes the force of the biasing element 314. As such, the gating plate 212 separates from the hinge 206.

In the example of FIG. 6A and FIG. 6B, the engagement surface 216 slides along the base panel 300 from a first position near the hinge 206 to a second position toward the bottom of the base panel 300 as the angle between the display panel 202 and the base panel 300 increases past 90 degrees. In some examples, the base panel 300 includes a tuned profile along which the engagement surface 216 moves. In some examples, the engagement surface 216 is a rounded element, a bulbous end, and/or a cylinder. As the engagement surface 216 slides along the base panel 300 from the first position near the hinge 206 to the second position toward the rear end of the base panel 300, the gating plate 212 moves to the second or the deployed position. Thus, in this example, movement of the gating plate 212 between the stowed and the deployed positions is based on an angle of the display panel 202 relative to the base panel 300. In the example of FIG. 6A and FIG. 6B, the gating plate 212 is in the fully deployed position when the display panel 202 and the base panel 300 are separated by about 135 degrees or more.

In some examples, the engagement surface 216 and the surface of the base panel 300 along which the engagement surface 216 travels form a cam and follower. In other words, the surface of the base panel 300 forms a cam, and the engagement surface 216 forms a follower. In some examples, deployment of the gating plate 212 depends on the shape of the cam. For example, if the cam (the surface of the base panel 300) has a shallow curve, the gating plate 212 will move to the deployed position later in the motion of the hinge 206 (i.e., after the display panel 202 is opened to a relatively larger angle). If the cam (the surface of the base panel 300) has a steeper curve, the gating plate 212 will move to the deployed position sooner in the motion of the hinge 206 (i.e., after the display panel 202 is opened to a relatively smaller angle).

In the deployed position, the gating plate 212 reduces (e.g., prevents) airflow from the exhaust vent 306 to the intake vent 304. Thus, the gating plate 212 acts as a barrier or gate for reducing (e.g., eliminating) recirculating airflow. In some examples, the gating plate 212 completely prevents airflow between the display panel 202 and the base panel 300 when in the deployed position. In some examples, when in the deployed position, the gating plate 212 directs airflow from the exhaust vent 306 in a direction toward the display 204 and/or between the hinge 206 and the display panel 202 but not back toward the intake vents 304 leading to the fan 302.

When the display panel 202 is closed again, at a certain angle relative to the base panel 300 (e.g., less than 90 degrees), the engagement surface 216 is released from contact with the base panel 300. After the engagement surface 216 disengages from the base panel, the biasing element 314 and/or the first magnet 316 and the second magnet 318 move the gating plate 212 to the stowed position.

The spring constant of the biasing element 314 and/or the magnetic strength of the first magnet 316 and/or the second magnet 318 affect the force needed to deploy the gating plate 212. The spring constant of the biasing element 314 and/or the magnetic strength of the first magnet 316 and/or the second magnet 318 can be tuned based on profile geometries of the gating plate 212, the engagement surface 216, and/or the base panel 300 to achieve different forces of opening the electronic device 200 and deploying the gating plate 212.

Recirculation of fan exhaust negatively affects the thermal operation of the electronic device 200. For example, even a small 0.2 cubic feet per minute recirculation of 60 degree Celsius fan exhaust, can increase the thermal toll on the electronic device by about 3 Watts. Examples disclosed herein prevent recirculation of fan exhaust. Thus, the operation of the fan 302 is more efficient with the examples disclosed herein. Therefore, larger and/or additional fans are not needed for the same thermal effect, which allows for lower acoustic noise from fans. In addition, without the need for larger and/or additional fans, the electronic device 200 can have a thinner profile and lighter weight. Moreover, cooling can be achieved more efficiently with less energy expenditure. Thus, examples disclosed herein achieve improvements in the operations of device such as laptop computers.

The action of the gating plate 212 is agnostic or otherwise unknown to the user. Thus, the user has a smooth and ergonomic experience when using the electronic device 200.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

Systems, apparatus, articles of manufacture, and methods are disclosed to reduce or prevent fan exhaust recirculation in electronic devices.

Example 1 include an electronic device that includes a first panel; a second panel; a hinge coupling the first panel and the second panel; and a gating plate movable with the first panel to reduce recirculation of airflow in the second panel.

Example 2 includes the electronic device of Example 1, wherein the gating plate is moveable between a stowed position and a deployed position.

Example 3 includes the electronic device of Example 2, including a torsion spring to bias the gating plate to the stowed position.

Example 4 includes the electronic device of any of Examples 2 or 3, wherein the hinge includes a first magnet and the gating plate includes a second magnet, the first magnet attracted to the second magnet to pull the gating plate to the stowed position.

Example 5 includes the electronic device of any of Examples 2-4, wherein the gating plate includes an engagement surface to contact the second panel when the first panel and the second panel are separated by at least a threshold angle.

Example 6 includes the electronic device of Example 5, wherein the threshold angle is about 90 degrees or greater.

Example 7 includes the electronic device of any of Examples 5 or 6, wherein the gating plate is to move to the deployed position after contact of the engagement surface with the second panel and when the first panel and the second panel are separated by more than the threshold angle.

Example 8 includes the electronic device of any of Examples 1-7, wherein the hinge has a length, and the gating plate extends the length of the hinge.

Example 9 includes the electronic device of any of Examples 1-8, wherein the second panel includes an intake vent and an exhaust vent, and the gating plate is to prevent the recirculation of the airflow between the exhaust vent and the intake vent.

Example 10 includes an electronic device that includes a display panel; a base panel including a fan, an intake vent, and an exhaust vent; a hinge coupling the display panel and the base panel; and a gating plate to move between a stowed position and a deployed position, the gating plate to engage the base panel in the deployed position and to separate from the base panel in the stowed position.

Example 11 includes the electronic device of Example 10, including a biasing element to bias the gating plate to the stowed position.

Example 12 includes the electronic device of any of Examples 10 or 11, wherein in the deployed position, the gating plate directs airflow from the exhaust vent in a direction away from the intake vent.

Example 13 includes the electronic device of any of Examples 10-12, including a magnet to urge the gating plate to the stowed position.

Example 14 includes the electronic device of any of Examples 10-13, wherein the gating plate is to contact the base panel based on an angle of the display panel relative to the base panel.

Example 15 includes the electronic device of Example 14, wherein the gating plate is to contact the base panel when the display panel is opened at least about 90 degrees relative to the base panel.

Example 16 includes the electronic device of Example 15, wherein the gating plate is to slide along the base panel from a first position near the hinge to a second position toward a rear of the base panel as the angle between the display panel and the base panel increases to greater than about 90 degrees.

Example 17 includes the electronic device of any of Examples 10-16, wherein movement of the gating plate between the stowed and the deployed position is based on an angle of the display panel relative to the base panel.

Example 18 includes the electronic device of Example 17, wherein the gating plate is to move to the deployed position when the angle of the display panel relative to the base panel is at least about 135 degrees.

Example 19 includes the electronic device of any of Examples 17 or 18, wherein the gating plate is to move to the stowed position when the angle of the display panel relative to the base panel is about 90 degrees or less.

Example 20 includes the electronic device of any of Examples 10-19, wherein the exhaust vent is on a rear of the base panel near the hinge and the intake vent is on a bottom of the base panel, the gating plate to prevent airflow from the exhaust vent to the intake vent.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An electronic device comprising:
a first panel;
a second panel;
a hinge coupling the first panel and the second panel; and
a gating plate movable with the first panel to reduce recirculation of airflow in the second panel.

2. The electronic device of claim 1, wherein the gating plate is moveable between a stowed position and a deployed position.

3. The electronic device of claim 2, including a torsion spring to bias the gating plate to the stowed position.

4. The electronic device of claim 2, wherein the hinge includes a first magnet and the gating plate includes a second magnet, the first magnet attracted to the second magnet to pull the gating plate to the stowed position.

5. The electronic device of claim 2, wherein the gating plate includes an engagement surface to contact the second panel when the first panel and the second panel are separated by at least a threshold angle.

6. The electronic device of claim 5, wherein the threshold angle is about 90 degrees or greater.

7. The electronic device of claim 5, wherein the gating plate is to move to the deployed position after contact of the engagement surface with the second panel and when the first panel and the second panel are separated by more than the threshold angle.

8. The electronic device of claim 1, wherein the hinge has a length, and the gating plate extends the length of the hinge.

9. The electronic device of claim 1, wherein the second panel includes an intake vent and an exhaust vent, and the gating plate is to prevent the recirculation of the airflow between the exhaust vent and the intake vent.

10. An electronic device comprising:
a display panel;
a base panel including:
a fan;
an intake vent; and
an exhaust vent;
a hinge coupling the display panel and the base panel; and
a gating plate to move between a stowed position and a deployed position, the gating plate to engage the base panel in the deployed position and to separate from the base panel in the stowed position.

11. The electronic device of claim 10, including a biasing element to bias the gating plate to the stowed position.

12. The electronic device of claim 10, wherein in the deployed position, the gating plate directs airflow from the exhaust vent in a direction away from the intake vent.

13. The electronic device of claim 10, including a magnet to urge the gating plate to the stowed position.

14. The electronic device of claim 10, wherein the gating plate is to contact the base panel based on an angle of the display panel relative to the base panel.

15. The electronic device of claim 14, wherein the gating plate is to contact the base panel when the display panel is opened at least about 90 degrees relative to the base panel.

16. The electronic device of claim 15, wherein the gating plate is to slide along the base panel from a first position near the hinge to a second position toward a rear of the base panel as the angle between the display panel and the base panel increases to greater than about 90 degrees.

17. The electronic device of claim 10, wherein movement of the gating plate between the stowed and the deployed position is based on an angle of the display panel relative to the base panel.

18. The electronic device of claim 17, wherein the gating plate is to move to the deployed position when the angle of the display panel relative to the base panel is at least about 135 degrees.

19. The electronic device of claim 17, wherein the gating plate is to move to the stowed position when the angle of the display panel relative to the base panel is about 90 degrees or less.

20. The electronic device of claim 10, wherein the exhaust vent is on a rear of the base panel near the hinge and the intake vent is on a bottom of the base panel, the gating plate to prevent airflow from the exhaust vent to the intake vent.
